(19) United States
(12) Patent Application Publication
(10) Pub. No.: US 2017/0153399 A1
(43) Pub. Date: Jun. 1, 2017

(54) MODULAR INTERFACE CONVERTER FOR FIBER OPTIC CASSETTES AND MODULES

(71) Applicant: Corning Optical Communications LLC, Hickory, NC (US)

(72) Inventor: Diana Rodriguez, Fort Worth, TX (US)

(21) Appl. No.: 15/365,074

(22) Filed: Nov. 30, 2016

Related U.S. Application Data
(60) Provisional application No. 62/260,779, filed on Nov. 30, 2015.

(51) Int. Cl. G02B 6/38; G02B 6/44

(52) U.S. Cl. CPC G02B 6/3897; G02B 6/4454; G02B 6/4452

(57) ABSTRACT

A modular interface converter for fiber optic cassettes and modules is disclosed. The fiber optic module comprises a plurality of orifices disposed proximate a periphery of an opening for receiving a fiber optic connector. A first plurality of orifices are configured to receive respective protrusions disposed on a simplex or duplex fiber optic connector. A second plurality of orifices are configured to receive respective protrosions disposed on an interface converter, wherein the interface converter is configured to receive a multi-fiber fiber optic connector.

### CROSS-REFERENCE TO RELATED APPLICATION

This application claims the benefit of priority under 35 U.S.C. §119 of U.S. Provisional Application Ser. No. 62/260,779 filed on Nov. 30, 2015 the content of which is relied upon and incorporated herein by reference in its entirety.

### BACKGROUND

Field

The technology of the disclosure relates to fiber optic hardware and, more particularly, to fiber optic cassettes and modules with modular, toollessly-connectable interfaces that support multiple types of connectors in a single module footprint.

Technical Background

Benefits of optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, fiber optic equipment is located in data distribution centers or central offices to support interconnections. For example, the fiber optic equipment can support interconnections between servers, storage area networks (SANs), and other equipment at data centers. Interconnections may be supported by fiber optic patch panels or modules.

The fiber optic equipment is customized based on the application and connection bandwidth needs. The fiber optic equipment is typically included in housings that are mounted in equipment racks to optimize use of space. The data rates that can be provided by equipment in a data center are governed by the connection bandwidth supported by the fiber optic equipment. The bandwidth is governed by the number of optical fiber ports included in the fiber optic equipment and the data rate capabilities of a transceiver connected to the optical fiber ports. When additional bandwidth is needed or desired, additional fiber optic equipment can be employed or scaled in the data center to increase optical fiber port count. However, increasing the number of optical fiber ports can require more equipment rack space in a data center. Providing additional space for fiber optic equipment increases costs. A need exists to provide fiber optic equipment that provides a foundation in data centers for migration to high density patch fields and ports and greater connection bandwidth capacity to provide a migration path to higher data rates while minimizing the space needed for such fiber optic equipment.

### SUMMARY

The application discloses an interface component that is adapted to convert a snap-fit simplex or duplex fiber optic connector to a multi-fiber connector using the same existing snap-fit architecture. In some embodiments, the solutions described herein provide a field-swappable solution, without requiring the use of specialized tools and, in some cases, support altogether toollessly-actuated capabilities.

In accordance with one aspect, the present disclosure is directed to a fiber optic module. The fiber optic module may comprise a plurality of orifices disposed proximate a periphery of an opening for receiving a fiber optic connector. The plurality of orifices may be configured to receive respective protrusions disposed on a simplex or duplex fiber optic connector. The plurality of orifices may also be configured to receive respective protrusions disposed on an interface converter, the interface converter configured to receive a multi-fiber fiber optic connector.

Additional features and advantages will be set forth in the detailed description which follows, and in part will be readily apparent to those skilled in the art from the description or recognized by practicing the embodiments as described in the written description and embodiments hereof, as well as the appended drawings.

It is to be understood that both the foregoing general description and the following detailed description are merely exemplary, and are intended to provide an overview or framework to understand the nature and character of the embodiments.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1A is a view of a fiber optic module with duplex connectors installed on the front of the module and a multi-fiber connector disposed on the rear of the module, consistent with certain disclosed embodiments;

FIG. 1B depicts a fiber optic module in a port-tap, multi-fiber connector configuration, in accordance with certain disclosed embodiments;

FIGS. 2A and 2B provide top, front, side, and perspective views of a modular interface converter, consistent with certain disclosed embodiments;

FIGS. 3A and 3B show the modular interface converter on the front of a fiber optic module in pre-installed and installed states, respectively;

FIG. 4A shows a plurality of modular interface converters on the front of a fiber optic module, one of which is populated with a multi-fiber port and the other of which is configured for future expansion;

FIG. 5 illustrates a fiber optic splice cassette having the modular interface converter to support customizable simplex or duplex connectors and multi-fiber connector configurations;

FIG. 6A shows a rear perspective view of a fiber optic module having the modular interface converter to support customizable simplex or duplex connectors and multi-fiber connector configurations; and

FIG. 6B shows a front perspective view of a fiber optic module having the modular interface converter to support customizable simplex or duplex connectors and multi-fiber connector configurations.

### DETAILED DESCRIPTION

Conventional solutions include replacing the current MPO/LC breakout duplex modules with MPO panels/modules when converting to 8-fiber links for parallel transmission. However, there is a need for flexibility to convert back to 2-fiber links as needed when network requirements change, such as new lower bandwidth equipment placed in cabinet, or a new technology evolving that only requires 2-fiber duplex connectivity. There is also a need for flexible solutions for flexible solutions that allow for customizing simplex/duplex and multi-fiber connection configurations, thereby reducing the need for multiple module configurations. Hence, the ability to easily convert between simplex/duplex and multi-fiber is desired and not currently available with conventional networks.

The present disclosure is directed to solutions for migrating between simplex/duplex and multi-fiber connectors without the use of specialized tools. Generally speaking, a module will include an enclosure having an internal chamber and a panel assembly will not have an enclosure. A fiber harness is typically installed into the internal chamber of the module for protecting the same. Panel assemblies may be used for optical connection such as a fiber optic panel assembly comprising a front panel disposed at a front end with a linear array of fiber optic adapters arranged in a width direction in the front panel in a BASE-8 configuration. Further, the BASE-8 fiber optic equipment such as the fiber optic panel assembly or module may compactly mount into a tray using ⅙ of the tray width or less. In another embodiment, the fiber optic panel assembly has a first and second multi-fiber adapter disposed at a front end of the fiber optic panel assembly and at least one pass-through channel at the rear side. Another piece of fiber optic equipment is the hybrid fiber optic module that supports connections for eight LC connections and an 8-fiber MPO connection at the front end, and which provides a quick and easy migration node in the network.

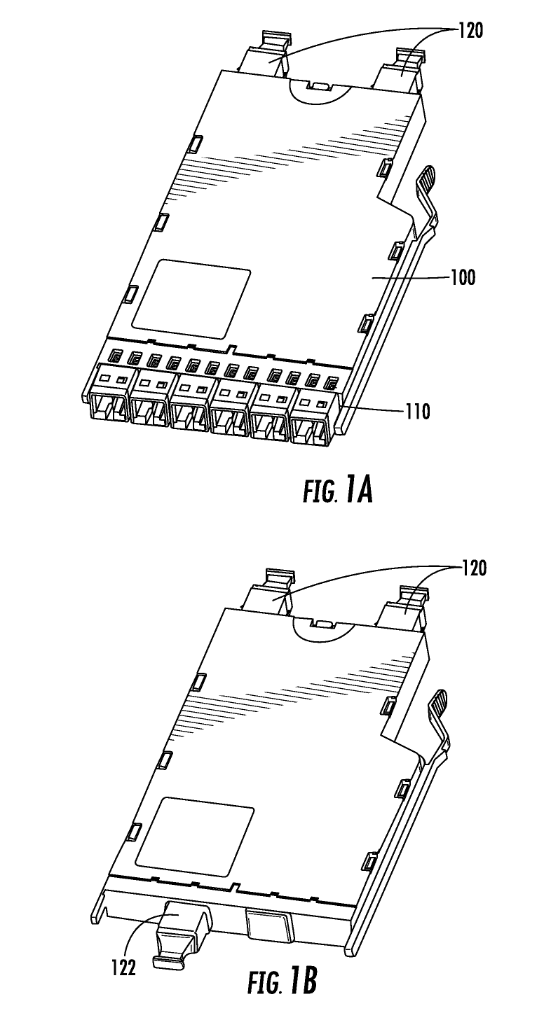

Against the background of the above disclosed embodiment of a fiber optic module/cassette, the form factor of the fiber optic module 100 will now be described in connection with the embodiments shown in FIGS. 1A and 1B. The form factor of the fiber optic module 100 allows a high density of fiber optic components 110 to be disposed within a certain percentage area of the front of the fiber optic module 100 thus supporting a particular fiber optic connection density and bandwidth for a given type of fiber optic component 110. Fiber optic component 110 may comprise a simplex or duplex connector, such as LC or SC simplex or duplex. The fiber optic module 100 may include a plurality of fibers that are routed within the housing of the fiber optic module to a multi-fiber connector 120, such as an MTP or MPO connector. When this fiber optic module 100 form factor is combined with the ability to support up to twelve (12) fiber optic modules 100 in a 1-U space, as described by the exemplary chassis example above, a higher fiber optic connection density and bandwidth is supported and possible. As an alternative or in addition to the configuration shown in FIG. 1A, FIG. 1B illustrates an embodiment having a multi-fiber connector 120 on the front end (in place of fiber optic components 110), as well as a multi-fiber connector on the back end of the fiber optic module 100.

According to certain embodiments consistent with the present disclosure, fiber optic modules 100 can be installed in fiber optic equipment trays to provide fiber optic connections in a larger cabinet or equipment chassis. The fiber optic module 100 may comprise a main body receiving a cover. An internal chamber disposed inside the main body and the cover and is configured to receive or retain optical fibers or a fiber optic cable harness, as will be described in more detail below. The main body is disposed between a front side and a rear side of the main body. Fiber optic components 110 can be disposed through the front side of the main body and configured to receive fiber optic connectors connected to fiber optic cables (not shown). In this example, the fiber optic components 110 may be duplex LC fiber optic adapters that are configured to receive and support connections with duplex LC fiber optic connectors. However, any fiber optic connection type desired can be provided in the fiber optic module. The fiber optic components 110 are connected to a fiber optic component 120 disposed through the rear side of the main body. In this manner, a connection to the fiber optic component creates a fiber optic connection to the fiber optic component 120. In this example, the fiber optic component 120 is a multi-fiber MPO fiber optic adapter equipped to establish connections to multiple optical fibers (e.g., either twelve (12) or twenty-four (24) optical fibers). The fiber optic module 100 may also manage polarity between the fiber optic components 110.

The module rails may be disposed on each side of the fiber optic module 100. As previously discussed, the module rails are configured to be inserted within module rail guides in the fiber optic equipment tray. In this manner, when it is desired to install a fiber optic module 100 in the fiber optic equipment tray, the front side of the fiber optic module 100 can be inserted from either the front end or the rear end of the fiber optic equipment tray.

The fiber optic components 110 are disposed through a front opening disposed along a longitudinal axis in the front side of the main body. In this embodiment, the fiber optic components 110 are duplex LC adapters, which support single or duplex fiber connections and connectors. The duplex LC adapters in this embodiment contain protrusions that are configured to engage with orifices 130 disposed on the main body to secure the duplex LC adapters in the main body in this embodiment. A cable harness is disposed in the internal chamber with fiber optic connectors disposed on each end of optical fibers connected to the duplex LC adapters and the fiber optic component 120 disposed in the rear side of the main body. The fiber optic component 120 in this embodiment is an MPO fiber optic adapter. Two vertical members are disposed in the internal chamber of the main body, as illustrated in, to retain the looping of the optical fibers of the cable harness. The vertical members and the distance therebetween are designed to provide a bend radius in the optical fibers no greater than forty (40) mm and preferably twenty-five (25) mm or less in this embodiment.

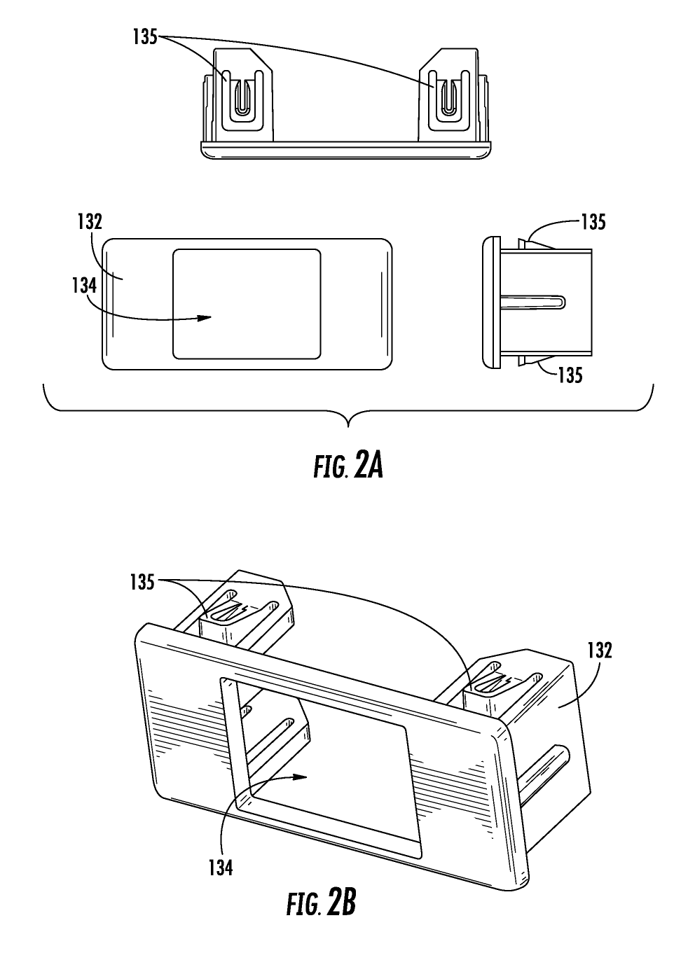

FIGS. 2A and 2B provide top, front, side, and perspective views of a modular interface converter 132, consistent with certain disclosed embodiments. The modular interface converter 132 may be configured to snap-fit into fiber optic module 100, in place of one or more fiber optic connectors 110 to convert the opening of the fiber optic module 100 to a different connector type, such as to support a multi-fiber connector. The modular interface converter 132 in this embodiment contain protrusions 135 that are configured to engage with orifices 130 disposed on the main body to secure the modular interface converter 132 in the main body in this embodiment.

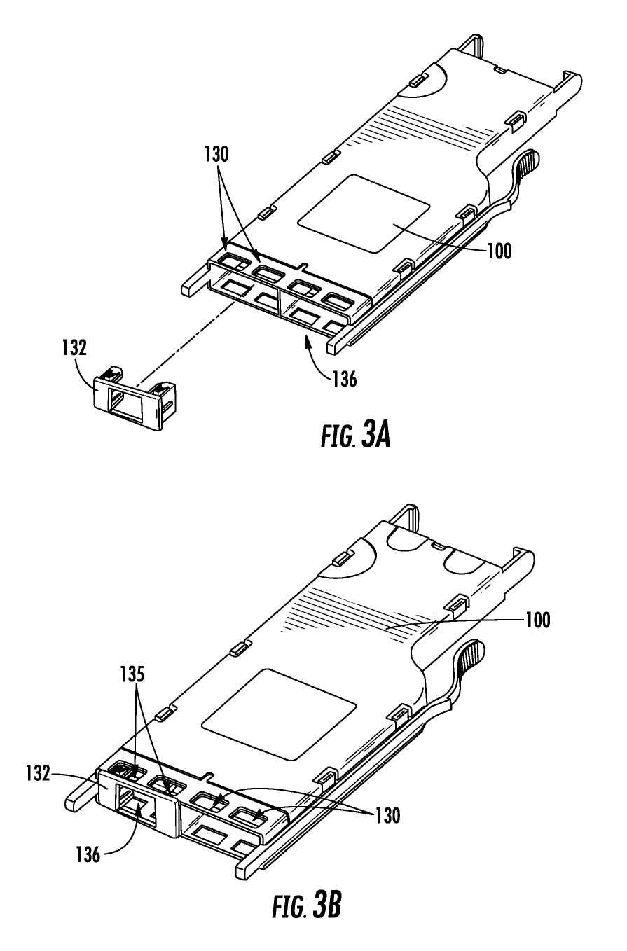

FIG. 3A illustrates a perspective front view of the fiber optic module 100 without loaded fiber optic components 110 in the front side to further illustrate the form factor of the fiber optic module 100. As previously discussed, the front opening 136 is disposed through the front side of the main body to receive the fiber optic components. The greater the width of the front opening 136, the greater the number of fiber optic components 110 that may be disposed in the fiber optic module 100. Greater numbers of fiber optic components 110 equates to more fiber optic connections, which supports higher fiber optic connectivity and bandwidth. However, the larger the width of the front opening, the greater the area required to be provided in the chassis for the fiber optic module 100.

As explained, the modular interface converter 132 may be configured to snap-fit into fiber optic module 100, in place of one or more fiber optic connectors 110 to convert the opening of the fiber optic module 100 to a different connector type, such as to support a multi-fiber connector. FIG. 3B illustrates a fiber optic module 100 with a modular interface converter 132 that is snap-fit into fiber optic module 100. The modular interface converter 132 in this embodiment contains protrusions 135 that are configured to engage with orifices 130 disposed on the main body to secure the modular interface converter 132 in the main body in this embodiment.

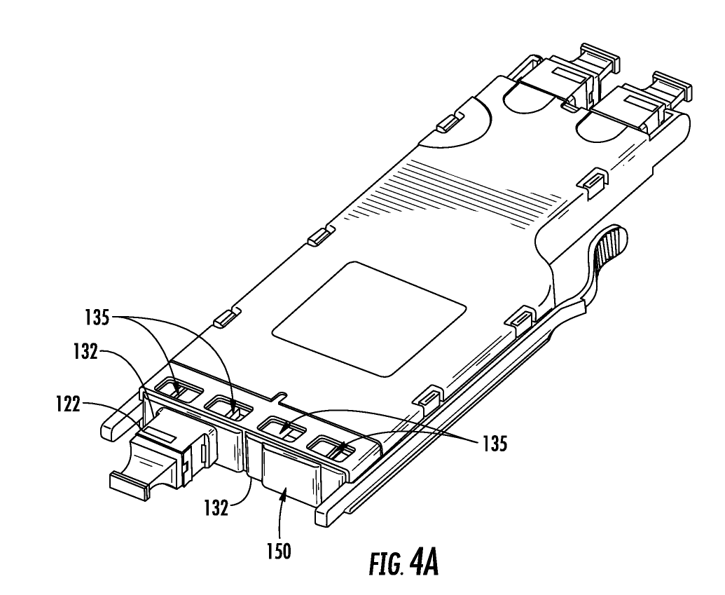

FIG. 4A illustrates a perspective front view of the fiber optic module 100 showing two module interface converters 132 loaded into fiber optic module 100. The left module interface converter 132 is configured with a multi-fiber connector, such as an 8-fiber MPO connector, while the right module interface converter 132 is configured with an expansion cover 150, for later retro-fitting with a desired connector.

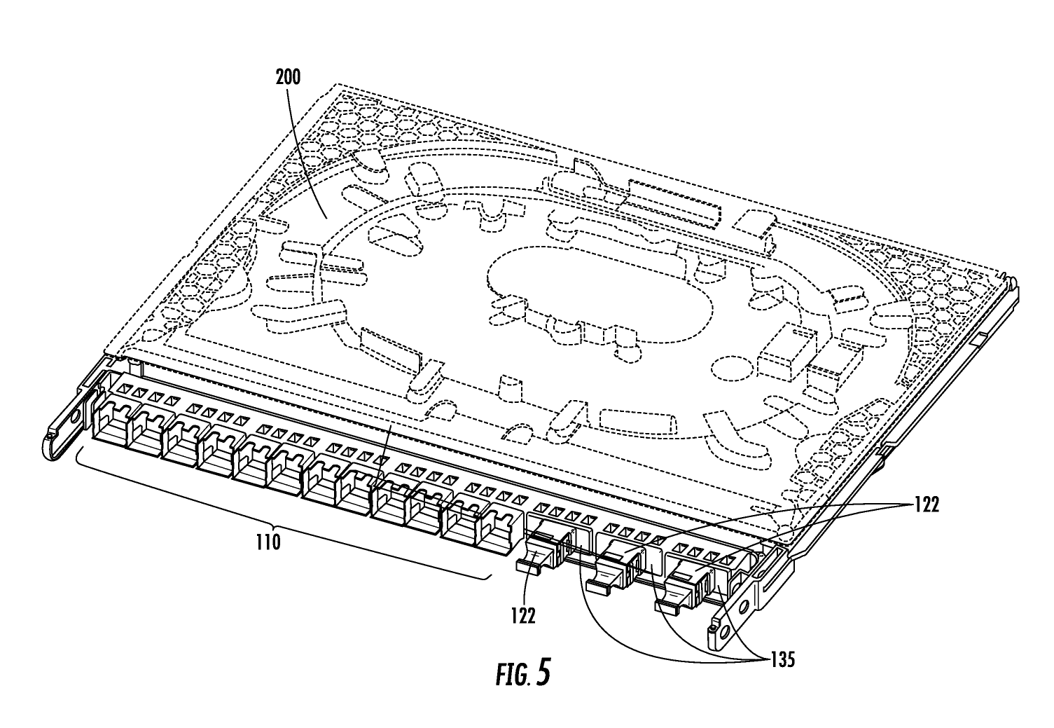

Alternate fiber optic modules with alternative fiber optic connection densities are possible. FIG. 5 is a front perspective view of an alternate fiber optic module or cassette 200 that can be installed in the fiber optic equipment tray of an equipment chassis. The form factor of the fiber optic module 200 is different than the form factor of the fiber optic module 100 illustrated in FIGS. 1-4A. However, in the fiber optic module 200 of FIG. 5, three (3) MPO fiber optic adapters 122 are disposed through the front opening of the fiber optic module 200 along with a linear array of duplex LC adapter using a plurality of modular interface converters 132 to support the connection of the MPO adapters. As shown in FIG. 5, the presently disclosed modular interface adapter 132 allows for the customization of the front of module 100, 200 without requiring separate, customized solutions for supporting different connector configurations.

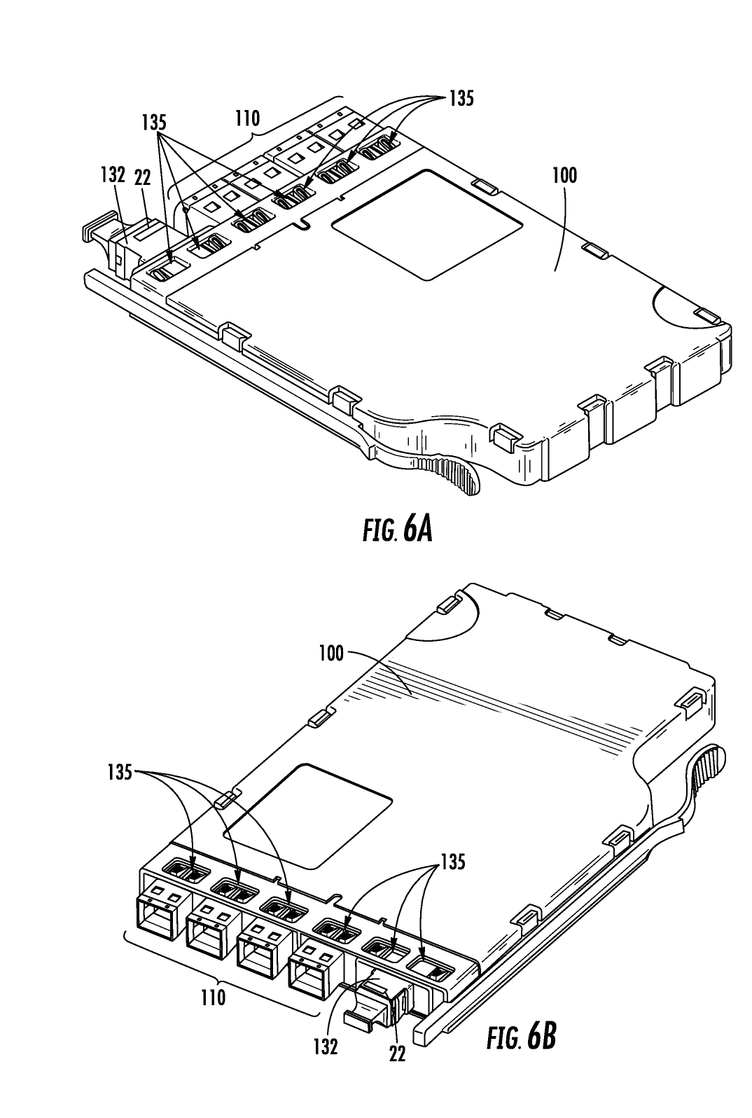

FIG. 6A shows a rear perspective view of a fiber optic module having the modular interface converter to support customizable simplex or duplex connectors and multi-fiber connector configurations. FIG. 6B shows a front perspective view of a fiber optic module having the modular interface converter to support customizable simplex or duplex connectors and multi-fiber connector configurations. FIGS. 6A and 6B illustrate the flexibility of the presently-disclosed modular interface converter, allowing conventional opening for LC simplex connectors, for example, to support additional and/or different connectors, such as MTP or MPO multi-fiber connectors.

Unless otherwise expressly stated, it is in no way intended that any method set forth herein be construed as requiring that its steps be performed in a specific order. Accordingly, where a method embodiment does not actually recite an order to be followed by its steps or it is not otherwise specifically stated in the embodiments or descriptions that the steps are to be limited to a specific order, it is no way intended that any particular order be inferred.

It will be apparent to those skilled in the art that various modifications and variations can be made without departing from the spirit or scope of the disclosure. Since modifications combinations, sub-combinations and variations of the disclosed embodiments incorporating the spirit and substance of the disclosure may occur to persons skilled in the art, the disclosure should be construed to include everything within the scope of the appended embodiments and their equivalents.

We claim:

1. A fiber optic module, comprising:
a plurality of orifices disposed proximate a periphery of an opening for receiving a fiber optic connector, the plurality of orifices configured to:
receive respective protrusions disposed on a simplex or duplex fiber optic connector; and
receive respective protrosions disposed on an interface converter, the interface converter configured to receive a multi-fiber fiber optic connector.

2. The fiber optic module of claim 1, wherein the simplex or duplex fiber optic connector comprise a simplex LC fiber optic adapter.

3. The fiber optic module of claim 1, wherein the simplex or duplex fiber optic connector comprise a duplex LC fiber optic adapter.

4. The fiber optic module of claim 1, wherein the multi-fiber fiber optic connector comprises an MTP fiber optic adapter.

5. The fiber optic module of claim 1, wherein the multi-fiber fiber optic connector comprises an MPO fiber optic adapter.

6. The fiber optic module of claim 1, wherein the simplex or duplex fiber optic connector comprises a linear array of simplex or duplex fiber optic adapters.

7. A fiber optic module, comprising:
a plurality of orifices disposed proximate a periphery of an opening for receiving a fiber optic connector, a first plurality of orifices configured to receive respective protrusions disposed on a simplex or duplex fiber optic connector, a second plurality of orifices configured to receive respective protrosions disposed on an interface converter, the interface converter configured to receive a multi-fiber fiber optic connector.

8. The fiber optic module of claim 7, wherein the simplex or duplex fiber optic connector comprise a simplex LC fiber optic adapter.

9. The fiber optic module of claim 7, wherein the simplex or duplex fiber optic connector comprise a duplex LC fiber optic adapter.

10. The fiber optic module of claim 7, wherein the multi-fiber fiber optic connector comprises an MTP fiber optic adapter.

11. The fiber optic module of claim 7, wherein the multi-fiber fiber optic connector comprises an MPO fiber optic adapter.

12. The fiber optic module of claim 7, wherein the simplex or duplex fiber optic connector comprises a linear array of simplex or duplex fiber optic adapters.
